(19) United States
(12) Patent Application Publication
(10) Pub. No.: US 2005/0288205 A1
(43) Pub. Date: Dec. 29, 2005

(54) Phenylethyl benzoate for use in anti-perspirants and personal care products

(75) Inventors: Ismail I. Walele, Saddle Brook, NJ (US); Samad A. Syed, Paramus, NJ (US)

Correspondence Address: WEINGRAM & ASSOCIATES P.C., P.O. BOX 927, MAYWOOD, NJ, 07607, US

(73) Assignee: FINETEX, INC.

(21) Appl. No.: 11/141,706

(22) Filed: May 31, 2005

Related U.S. Application Data
(63) Continuation of application No. 10/757,012, filed on Jan. 14, 2004, now abandoned.

(51) Int. Cl. C11D 3/00

(52) U.S. Cl. 510/392

(57) ABSTRACT

Phenylethyl benzoate for use in antiperspirant compositions, as well as an emollient additive, is disclosed. Personal care compositions such as antiperspirants, shampoos and hair conditioners comprising phenylethyl benzoate in the amount of from about 0.5% to about 50% by weight of the composition are disclosed.

### BACKGROUND OF THE INVENTION

1. Field of the Invention

The present invention relates to benzoic acid esters, and more particularly to the use of phenylethyl benzoate as a cosmetic ingredient for toiletry, cosmetic and anti-perspirant formulations, particularly as an emollient additive in view of its high refractive index.

2. Description of the Related Art

Esters are known for a variety of different applications for cosmetic, pharmaceutical and medicinal purposes. Numerous references describe the production and use of benzoic acid esters. None of these references teach or suggest the specific uses of the benzoate ester of this invention in cosmetics, toiletries and personal care products such as antiperspirants for other than perfume fragrance purposes.

For example, benzoate esters of certain alcohols and alcohol mixtures and their uses are disclosed in assignee's U.S. Pat. Nos. 4,323,694; 4,322,545; and 4,275,222, all to Scala; and U.S. Pat. Nos. 4,791,097; 5,270,461; and 5,271,930, all to Walele et al. U.S. Pat. Nos. 5,500,138; 5,668,094 and 6,491,728 to Bacon et al. discloses liquid and solid fabric softener compositions and liquid laundry detergent compositions, combined with enduring perfumes, such as phenylethyl benzoate.

U.S. Pat. Nos. 5,843,881 and 6,126,930 to Dubois et al. disclose a composition for use on the skin, hair or mucosa comprising an alcohol, a personal care polymer, and an alcohol-masking perfume component, such as phenylethyl benzoate, which reduces the alcohol aroma and the stinging sensation in the nose or throat due to the alcohol when the compositions are sprayed or atomized.

U.S. Pat. Nos. 5,540,853; 5,833,999; 5,849,310 and 6,086,903 to Trinh et al. disclose personal treatment compositions containing from about 0.001% to about 50% enduring perfume compositions selected from the group including phenylethyl benzoate.

Phenylethyl benzoate is known to have utility as a perfume ingredient for use in perfumes, colognes, eye and throat oils, stick rouge, skin moisturizers, cleansing creams, and after-bath splash and lotions.

However, among the foregoing patents, none have the unique properties of the ester compositions described and claimed herein for use in antiperspirants. None disclose or suggest phenylethyl benzoate that is substantially non-greasy and non-oily, has very low cloud point and pour point, has a high refractive index, a bland odor, low toxicity and is stable. These are vital properties in numerous applications, as the esters may be incorporated into personal care products, cosmetics and toiletries, including anti-perspirants.

3. Object and summary of the Invention

It is an object of the invention to provide phenylethyl benzoate for use as an emollient additive in cosmetics, toiletries, and personal care products, such as anti-perspirants.

### DESCRIPTION OF THE INVENTION

It has now been found that phenylethyl benzoate has unique properties in that it is substantially non-greasy and non-oily, has a very low cloud point and pour point, has a bland odor, low toxicity, a high refractive index, and is stable. These properties make the ester useful as an emollient additive for toiletry and cosmetic formulations and personal care products, such as hair creams, hand cleaners, bath oils, cold creams, electric preshaves, finger nail polish, topical pharmaceutical ointments, lipsticks, skin lotions and creams, as well as other formulations. The foregoing list is only exemplary of the type of compositions in which the esters of this invention may be used, and, as such, is not to be considered limiting.

The benzoate ester of the invention is represented by the following formula:
C6H5-CH2-CH2-O—C—

The chemical name and proposed INCI name of the compound is Phenylethyl benzoate.

The phenylethyl benzoate ester of the invention has the following featured properties:
Ease of emulsification.
High refractive index.
Emolliency with good after feel.
Lack of greasiness/pleasant skin feel.
Lack of oiliness while imparting good lubrication.
Low cloud point and pour point.
High spreading coefficient.
Alcohol solubility.
Additive for Antiperspirant formulations.
Low toxicity.
Hydrolytic stability.

The phenylethyl benzoate of the invention is prepared as described in Examples 1 and 2 below. The processes of Examples 1 and 2 differ in the catalyst used.

The phenylethyl benzoate of the invention is advantageous in that it is non-oily, tasteless, inert, essentially nontoxic and non-sensitizing, and is stable. Phenylethyl benzoate is useful as an emollient, moisturizer, plasticizer, and de-oiler/degreaser. Further, phenylethyl benzoate possesses other unusual physico-chemical properties, in particular, a higher spreading coefficient and high refractive index that can make it a beneficial and unique component of a sophisticated delivery system such as in hand, face, and body creams and lotions, and for anti-perspirants. The foregoing list is only exemplary of the type of composition in which phenylethyl benzoate may be used and as such, is not to be considered limiting.

The amount of phenylethyl benzoate used as an emollient additive, in an aqueous surfactant or antiperspirant composition is dependent on the type of composition, the type and quantity of other ingredients used, and the amount and type of functional additives that are utilized. Typically, the amount of phenylethyl benzoate used ranges from about 0.5% to about 50%, by weight, of the personal care compositions. Preferably, from about 0.5% to about 10% of phenylethyl benzoate is used. Phenylethyl benzoate ester may be used in skin care and personal care compositions. The amount used in skin care compositions is dependent on the type of skin care composition, the type and quantity of cosmetic ingredients used, and the amount and type of functional additives. Typically, the amount ranges from about 0.5% to about 80% by weight of the skin care composition. For example, a facial cream may have only about 0.5% of the phenylethyl benzoate ester, whereas a massage oil may have up to about 80% by weight. Still higher amounts may be used in other compositions; for example, up to 95% of the ester may be used in bath oils.

The ester of the invention also functions as a plasticizer for polymers contained in skin care compositions, and acts as an auxiliary suspending agent capable of assisting in the suspension of ingredients in skin care compositions. Thus, the phenylethyl benzoate ester when used in skin care compositions serves not only as an emollient but also exhibits one or more other functions. The skin care compositions may take the form of a liquid, cream, gel, paste, bar, granules, stick, emulsion, dispersion, suspension, powder, foam or spray, or other forms.

A particularly useful composition of this invention is for use in anti-perspirant compositions. Typically, the amount of phenylethyl benzoate used in anti-perspirants ranges from about 0.5% to about 25% by weight of the antiperspirant composition, and preferably from about 1% to about 10% by weight of the antiperspirant composition. The most commonly used antiperspirant actives are aluminum chlorohydrate and aluminum zirconium tetrachloro-glycine.

Typical adjunct ingredients in skin care compositions are selected from the group consisting of conditioning agents, fatty substances, organic solvents, thickening agents, emollients, emulsifiers, humectants, softeners, lubricants, penetrants, plasticizers, antioxidants, agents for combating free radicals, opacifiers, stabilizers, emollients, solvents and co-solvents, dispersants, silicones, alpha-hydroxy acids, buffers, chelating agents, foaming agents, antifoaming agents, moisturizing agents, vitamins, insect repellents, fragrances, preservatives, surfactants, anti-inflammatories, pH adjusters, chelating agents, fillers, polymers, propellants, basifying or acidifying agents, odor masking agents, tanning agents, colorants and mixtures thereof.

The following are non-limiting examples of uses of the ester of the invention in specific cosmetic or personal care anti-perspirant products as an emollient additive. In the Examples, as well as throughout this application, the chemical and scientific symbols have their customary meanings and all percents are weight percents unless otherwise specified.

Example Nos. 1 and 2 describe preparation of a Benzoate ester of phenylethyl alcohol, referred to herein as Finsolv SUN. Examples 3 through 6 identify anti-perspirant formulations using the ester of the invention. For ease of identification, each ester is identified by both an Example Number and a Reference No., where applicable. Color in the Examples below is measured using ASTM D-1209 on the APHA scale of the American Public Health Association. APHA scores less than 20 denote good color, with scores of 5 to 10 signifying superior color, i.e., clear color or absence of color. APHA scores over 20 are not good, as a yellow tint is visible, becoming progressively more colored as the APHA scores increase.

### EXAMPLE #1

### Ref. # 129-10

Preparation of Benzoate Ester of Phenylethyl Alcohol (FINSOLV SUN)

In a 2,000 ml. four neck round bottom flask equipped with glass stirrer, distillation head, condenser, thermometer and receiver, added 488.61 grams (1.0 moles) of Phenylethyl alcohol and 511.84 grams (1.05 moles) of Benzoic Acid. The temperature was raised to 60° C. with a good flow of Nitrogen. At 60° C. added 0.9 grams of Stannous Oxalate and continued to heat to 240° C. maintaining a good flow of Nitrogen over 120 minutes and held for 2 hours. The distillate as water of reaction collected was 70 grams against theoretical estimates of 76 grams. The ester had the acidity of 20 mg KOH/g and it was cooled to 40° C. under nitrogen. The crude ester was treated with 200 grams of deionized water containing 20 grams of Potassium Carbonate and 20.00 grams of Potassium Chloride at 80° C. When acidity of ester was <0.1 mg KOH/gram, it was treated with 5.0 grams of Hydrogen Peroxide. The top layer containing the benzoate ester was collected. It was vacuum stripped at 115° C.-120° C. and 20-25 mm of Hg vacuum. The liquid benzoate of this reaction was then treated with 0.2 grams each of magnesol, celaton FW 60 (diatomaceous earths) at 50° C. The product was filtered through a Filter Press with Whatman Paper #4. The net yield of the benzoate ester product was 935 grams.

### EXAMPLE #2

### Ref. # 129-154

Preparation of Benzoate Ester of Phenylethyl Alcohol (FINSOLV SUN)

In a 2,000 ml. four neck round bottom flasks equipped with glass stirrer, distillation head, condenser and receiver, added 488.61 grams (1.0 moles) of Phenylethyl alcohol and 511.84 grams (1.05 moles) of Benzoic acid. The temperature was raised to 60° C. with a good flow of Nitrogen. At 60° C. added 3.0 grams of Methane sulfonic acid and continued to heat to 150° C. maintaining a good flow of nitrogen over 60 minutes and held for 2 hours. The distillate collected was 70 grams against theoretical estimates of 76 grams. The ester had the acidity of 20 mg KOH/g. The reaction product was treated with 200 grams of deionized water containing 20.0 grams of sodium carbonate, 3 grams hydrogen peroxide and 20 grams of sodium sulfate at 80° C. The top layer containing the Benzoate ester was collected. It was vacuum stripped at 115° C.-120° C. and 20-25 mm of Hg vacuum. The liquid Benzoate of this reaction was then treated with 0.2 grams each of magnesol, celetom FW 60 (diatomaceous earths) at 50° C. The product was filtered through a Filter Press with Whatman Paper #4. The net yield of the Benzoate ester product was 946 grams. An analysis of the phenylethyl benzoate ester was conducted. Table I sets forth the typical physical and chemical properties that were observed.

TABLE 1

| | |
|---|---|
| % Actives | 100 |
| Appearance | Liquid |
| Odor | Rosy Odor |
| Freezing Point | −8° C. |
| Refractive index (at 25° C.) | 1.5600 |
| Surface Tension (° C.) | 31.5 |
| Spreading Coeffecient (° C.) | 32.75 |
| Viscosity (CPS) | 40 |
| Color (APHA) | 70 |
| % Water | 0.01 |
| Saponification value mg - KOH/gram | 245 |
| Specific gravity (at 25° C.) | 1.094 |
| Interfacial Tension (° C.) | 7.75 |

### EXAMPLE #3

### Ref. No. 134-72

Solubility of Phenylethyl Benzoate (Finsolv SUN)

The solubility characteristics of Phenylethyl Benzoate (Finsolv SUN) are tabulated in Table 2 below. It is soluble in most commonly used solvents, emollients and vehicles employed in cosmetic product formulations.

TABLE 2
SOLUBILITY OF PHENYLETHYL BENZOATE

| | |
|---|---|
| Water | − |
| Ethanol | + |
| Isopropanol | + |
| Mineral Oil | − |
| Glycerin | − |
| Propylene Glycol | − |
| Dimethione Copolyl (Silwet 7604& 7230) | + |
| Cyclomethicone (Dow Corning Fluid 244) | − |
| Dimethicone (Dow Corning Fluid 200) | − |
| Isopropyl Myristate | + |
| Isopropyl Palmitate | + |
| Finsolv SLB-101 | + |
| Finsolv SLB-201 | + |
| Finsolv PL 62 | + |
| Finsolv PL 355 | + |
| Finsolv BCO 115 | + |
| Finsolv BCR 111 | + |
| Finsolv BOHS 111 | + |
| Finsolv TN | + |
| Finsolv TPP | + |
| Finsolv EMG 20 | + |
| Finsolv BOD | + |
| Finsolv SB | + |
| Finsolv PG22 | + |
| Finester EH 25 | + |
| Finester DOM-R | + |

### EXAMPLE #4

### Ref. No. 134-150)

Soap Bar Evaluation

An evaluation of the use of phenylethyl benzoate in bar soaps was conducted as described below. The results show improvements in the properties of bar soaps upon inclusion of the phenylethyl benzoate ester of the invention.

Control bars: A soap bar containing 100% Syndet Base 96-143-1 available from Finetex, Inc. and a Combo Bar comprising 25% Syndet Base 96-143-1 and 75% Bradford soap base 80/20 have the following features during processing of the soap bars and after washing with said bars:
Runs well in the extruder
Good body with consistency, transparent or pearlescent effect
Good body texture
When using the bar to wash hands with water, it gives a creamy foam, with large, but not compact bubbles
After drying a soft feel was observed with no stickiness, and no gloss or shine observed.

To the above control soap bar containing 100% Syndet Base 96-143-1 and to the above control combo bar comprising 25% Syndet Base and 75% Bradford soap base 80/20, was added 1% Finsolv SUN. The typical processing was followed, i.e., Syndet Base 96-143-1 or combo bar (25% Syndet Base 96-143-1 and 75% Bradford Tallow/coco soap base 80/20) was added to the amalgamator with Finsolv SUN, fragrance was incorporated and the bar colored and refined as usual. The resulting bar was found to have the following additional beneficial properties in addition to those properties described above for the control bars:

Syndet and combo bars containing Finsolv SUN were found to run excellently in the extruder, have excellent body with better consistency than the control bars, have excellent transparent or pearlescent effect, and have excellent body texture. When washed with water, the bars produce dense bubbles, and a slippery feel was observed when the bars were wet. After drying, no stickiness was found on the skin. It had a nice, soft, silky feel and excellent shine and gloss were observed. The skin felt well moisturized.

### EXAMPLE #5

### Ref. Nos. 134-81, 134-82

Transparent Combo Bar

TABLE 3
Transparent Combo Bar Formulations

| | Formulation A | Formulation B |
|---|---|---|
| | (134-82) | (134-81) |
| Glycerin | 21.18 | 21.18 |
| Sorbitol 70% | 23.58 | 23.58 |
| Triethanolamine | 163 | 163 |
| Finsolv TN | 12 | — |
| Finsolv SUN | — | 12 |
| Surfine AZI-A | 15 | 15 |
| EDTA-NA | 1.2 | 1.2 |
| Sodium Chloride | 3 | 3 |
| Water | 46.92 | 46.92 |
| Coco fatty acid | 25.5 | 25.5 |
| Stearic acid | 25.5 | 25.5 |
| Sodium stearate | 9 | 9 |
| Soap base 80/20 | 239.92 | 239.92 |
| Tauranol I 78 C | 30.1 | 30.1 |

Procedure:

Add the ingredients listed in Table III from Glycerin to water in sequence, heat to 60° C. with mixing. Add coco fatty acid and stearic acid and mix. Heat to 70° C. and allow to dissolve. Add sodium stearate and soap base and mix. When it becomes clear, add Tauranol I 78 C. Mix and adjust moisture until clear liquid is formed. Discharge after deaeration.

### EXAMPLE #6

### Ref# 134-93

Non-Whitening Antiperspirant Stick

TABLE 4

| | | A | B | C |
|---|---|---|---|---|
| I. | Cyclomethicone | 39 | 39 | 39 |
| | Stearyl Alcohol | 18 | 18 | 18 |
| | Hydrogenated castor oil | 5 | 5 | 5 |
| | Finsolv SUN | 5 | — | — |
| | Isopropyl Myristate | — | 5 | — |
| | Isopropyl palmitate | — | — | 5 |
| | Finsolv116 | 10 | 10 | 10 |
| II. | Aluminum Zirconium tetrachlorohydroxy glycine | 20 | 20 | 20 |
| | Talc | 2 | 2 | 2 |
| | Silica | 1 | 1 | 1 |

Procedure:
1. Combine the ingredients of I and heat to 75° C. with mixing.
2. Add II powders. Mix 15 minutes or until completely dispersed. Maintain at 75° C.
3. Cool to 55° C., and mold sticks.

Formulations A to C so prepared were tested for emolliency, skin feel, slip and stick structure, on a scale of 1 to 5 with 1 representing the best and 5 representing poor. Results are as follows.

| | A | B | C |
|---|---|---|---|
| Emolliency | 2 | 4 | 4 |
| Skin feel | 2 | 3 | 3 |
| Slip | 1 | 3 | 4 |
| Stick structure | 1 | 2 | 3 |

### EXAMPLE #7

### Ref #134-94

Clear Deodorant Stick

TABLE 5

| | A | b | C |
|---|---|---|---|
| Propylene glycol | 71 | 71 | 71 |
| Water | 14 | 14 | 14 |
| Finsolv SUN | 3 | — | — |
| Isopropyl Myristate | — | 3 | — |
| Isopropylpalmitate | — | — | 3 |
| Sodium Stearate | 5 | 5 | 5 |
| Triclosan | 0.2 | 0.2 | 0.2 |
| Pentadoxynol-200 | 6.6 | 6.5 | 6.5 |
| Triethanolamine 99% | 0.3 | 0.3 | 0.3 |

Procedure: Charge all ingredients into a suitable vessel. Heat to 80° C., with mixing, allowing all to dissolve. Cool to 60° C. and cast into stick molds. Formulations A to C so prepared were tested for skin feel, slip, stick structure, emolliency and tackiness on a scale of 1 to 5, with 1 representing the best and 5 representing poor. Results are as follows:

| | A | B | C |
|---|---|---|---|
| Skin feel | 2 | 4 | 3 |
| Slip | 2 | 4 | 3 |
| Stick structure | 1 | 3 | 3 |
| Emolliency | 2 | 5 | 4 |
| Tackiness | 2 | 4 | 5 |

### EXAMPLE #8

### Ref # 134-95

Pump Spray Deodorant

TABLE 6

| | A | B | C |
|---|---|---|---|
| Cyclomethicone | 36.5 | 36.5 | 36.5 |
| Denatured Alcohol | 35.2 | 35.2 | 35.2 |
| Water | 2.7 | 2.7 | 2.7 |
| Triclosan | 0.2 | 0.2 | 0.2 |
| Finsolv SUN | 9 | — | — |
| Isopropyl myristate | — | 9 | — |
| Isopropyl palmitate | — | — | 9 |
| 1,3 Butylene glycol | 1 | 1 | 1 |
| PPG-3 Myristyl Ether | 15.5 | 15.5 | 15.5 |

Procedure:

Combine alcohol, water and Triclosan. Mix well. Add balance of ingredients with mixing. Formulations A, B and C so prepared were tested for skin feel, slip, dryness, emolliency and tackiness on a scale of 1 to 5, with 1 representing the best and 5 representing poor. Results are as follows:

| | A | B | C |
|---|---|---|---|
| Skin feel | 2 | 4 | 3 |
| Slip | 2 | 3 | 4 |
| Dryness | 1 | 3 | 3 |
| Emolliency | 2 | 4 | 4 |
| Tackiness | 2 | 3 | 4 |

### EXAMPLE #9

### Ref # 134-96

Cream Antiperspirant

TABLE 7

| | | A | B | C |
|---|---|---|---|---|
| I. | Glyceryl Stearate | 6 | 6 | 6 |
| | Propylene Glycol | 1 | 1 | 1 |
| | Finsolv SUN | 4 | — | — |
| | Isopropyl Myristate | — | 4 | — |
| | Isopropyl Palmitate | — | — | 4 |
| II. | Sodium Magnesium silicate | 1 | 1 | 1 |
| | Aluminium chlorohydrate 50% solution | 40 | 40 | 40 |
| | Water | 48 | 48 | 48 |

Procedure:
1. Disperse Sodium Magnesium Silicate in water and heat to 70° C.
2. Blend and heat the oil phase (ingredients of I) to 70° C.
3. Add the ingredients of I to the ingredients of II, with mixing.
4. Cool the cream to 50° C. and add Aluminium chlorohydrate.
5. Mix for 30 minutes and package.

Formulations A, B and C so prepared were tested for skin feel, slip, dryness, emoliiency and tackiness on a scale of 1 to 5, with 1 representing the best and 5 representing poor. Results are as follows:

| | A | B | C |
|---|---|---|---|
| Skin feel | 2 | 4 | 4 |
| Slip | 2 | 3 | 3 |
| Dryness | 1 | 3 | 4 |
| Emolliency | 2 | 4 | 3 |
| Tackiness | 2 | 4 | 4 |

### EXAMPLE #10

### Ref # 134-100

Emollient Cleansing Lotion

TABLE 8

| | | A | B | C |
|---|---|---|---|---|
| I. | Water | 80.4 | 80.4 | 80.4 |
| | Fizual MD 318 C | 1 | 1 | 1 |
| | Glycerin | 3 | 3 | 3 |
| | Carbopol ETD 2001 Resin | 0.2 | 0.2 | 0.2 |
| | Tetrasodium EDTA | 0.1 | 0.1 | 0.1 |
| II. | Finsolv SUN | 6.5 | — | — |
| | Isopropyl Myristate | — | 6.5 | — |
| | Isopropyl Palmitate | — | — | 6.5 |
| | Caprylic/capric Triglycerides | 1 | 1 | 1 |
| | Stearic acid | 3 | 3 | 3 |
| | Glyceryl stearate SE | 2 | 2 | 2 |
| III. | Water | 1 | 1 | 1 |
| | Triethanolamine 99% | 0.8 | 0.8 | 0.8 |
| IV. | Germaben II | 1 | 1 | 1 |

Procedure:

Disperse carbopol into water. Add balance of I ingredients and heat to 75° C. Mix II Ingredients together and heat to 75° C. Add II to I with mixing. Combine III ingredients, then add to balance and begin cooling. At 40° C., add ingredients of IV and continue cooling to 30° C. Formulations A, B and C so prepared were tested for slip, skin feel, and emolliency, on a scale of 1 to 5, with 1 representing the best and 5 representing poor. Results are as follows:

| | A | B | C |
|---|---|---|---|
| Skin feel | 2 | 4 | 3 |
| Slip | 1 | 3 | 3 |
| Emolliency | 2 | 4 | 4 |

### EXAMPLE # 11

### Ref # 134-101

Hand and Body Lotion

TABLE 9

| | | A | B | C |
|---|---|---|---|---|
| I. | Water | 85.75 | 85.75 | 85.75 |
| | Carbomer (Ultrez 10) | .15 | .15 | .15 |
| | Sorbitol 70% | 2 | 2 | 2 |
| | Tetrasodium EDTA | .2 | .2 | .2 |
| II. | Finsolv SUN | 6.5 | — | — |
| | Isopropyl Myristate | — | 6.5 | — |
| | Isopropyl Palmitate | — | — | 6.5 |
| | Cetyl alcohol | .7 | .7 | .7 |
| | Stearic acid | 1.5 | 1.5 | 1.5 |
| | Glyceryl stearate SE | .8 | .8 | .8 |
| | Cetearyl alcohol & ceteareth 20 | 1 | 1 | 1 |
| III. | Triethanolamine 99% | .9 | .9 | .9 |
| | Germaben II | .3 | .3 | .3 |

Procedure:

Disperse carbomer in water. Heat to 70° C. Add sorbitol 70% and tetrasodium EDTA. Weigh all II ingredients together and heat to 70° C. Add the ingredients of II to I with mixing. Add triethanoamine, continue mixing until 45° C. Add Germaben II as a preservative.

Formulations A, B and C so prepared were tested for skin feel, slip and emolliency on a scale of 1 to 5 with 1, representing the best and 5 representing poor. Results are as follows:

| | A | B | C |
|---|---|---|---|
| Skin feel | 2 | 4 | 4 |
| Slip | 2 | 4 | 3 |
| Emolliency | 1 | 3 | 3 |

### EXAMPLE #12

### Ref. # 134-102

Light Body Lotion

TABLE 10

| | | A | B | C |
|---|---|---|---|---|
| I. | Finsolv SUN | 5 | — | — |
| | Isopropyl Myristate | — | 5 | — |
| | Isopropylpalmitate | — | — | 5 |
| | Sesame oil | 4.4 | 4.4 | 4.4 |
| | Mineral oil | 4 | 4 | 4 |
| | Glyceral Monostearate | 1 | 1 | 1 |
| | Stearic acid | 2.4 | 2.4 | 2.4 |
| | Myristyl lactate | 1 | 1 | 1 |
| | Propylparaben | 0.2 | 0.2 | 0.2 |
| II. | Water | 74.95 | 74.95 | 74.95 |
| | Glycerin | 4.5 | 4.5 | 4.5 |
| | Triethanolamine 99% | 1.1 | 1.1 | 1.1 |
| | Methylparaben | .15 | .15 | .15 |

Procedure:

Mix ingredients of I and heat to 65° C. Mix ingredients of II and heat to 70° C. Add ingredients of I to ingredients of II with mixing, maintaining temperature of 70° C. Mix 15 minutes. Cool with mixing to 25° C.

Formulations A, B and C so prepared were tested for skin feel, slip and emolliency on a scale of 1 to 5, with 1 representing the best and 5 representing poor. Results are as follows:

| | A | B | C |
|---|---|---|---|
| Skin feel | 2 | 4 | 4 |
| Slip | 2 | 5 | 3 |
| Emolliency | 1 | 3 | 4 |

### EXAMPLE #13

### Ref. # 134-104

2 in 1 Conditioning Shampoo (Opaque Cream Type)

TABLE 11

| | | A | B | C |
|---|---|---|---|---|
| I. | Water | 53.4 | 53.4 | 53.4 |
| | Propylene Glycol | 1.5 | 1.5 | 1.5 |
| | Magnesium Aluminium Silicate | .25 | .25 | .25 |
| | Xanthum Gum | .25 | .25 | .25 |
| II. | Ammonium lauryl sulfate (28%) | 22 | 22 | 22 |
| | Ammonium laureth sulfate (25%) | 10 | 10 | 10 |
| | Surfine WLL | 2 | 2 | 2 |
| | Sodium chloride | 0.5 | 0.5 | 0.5 |
| | TetraSodium EDTA | 0.2 | 0.2 | 0.2 |
| | Cetrimonium chloride (30%) | 0.8 | 0.8 | 0.8 |
| III. | Aminol HCA | 4 | 4 | 4 |
| | Finsolv SUN | 2 | — | — |
| | Isopropyl Myristate | — | 2 | — |
| | Isopropyl palmitate | — | — | 2 |
| | Cetyl alcohol | 0.5 | 0.5 | 0.5 |
| | Stearyl alcohol | 0.5 | 0.5 | 0.5 |
| | Glycol stearate | 2 | 2 | 2 |
| IV. | DMDM Hydantoin | 0.1 | 0.1 | 0.1 |

Procedure:
1. Mix Gums (xanthum gum and magnesium aluminium silicate) together and pre-wet with Propylene Glycol.
2. Add Gums to water with good mixing to disperse. When dispersed, heat mixture to 65° C.
3. Add components of II at 65° C., with mixing, allowing each to become uniformly mixed before adding the next.
4. Add components of III together, heating to 65° C. with mixing until all melted.
5. Add Step 4 ingredients to balance of formula with good mixing and allow to become uniform. Continue mixing while cooling.
6. Add ingredients of IV at 45° C. Cool to 35° C. and discharge.

Table 12-A compares the properties of shampoo preparations of Formulations A, B and C of Example 13. Table 12-B compares foam results for shampoo of formulations A, B and C of Example 13. Table 12-C compares the effects of shampoo of formulations A, B and C of Example 13.

TABLE 12-A
(Properties of Shampoos A, B, C of Example 13)

| Shampoo preparation | Appearance | pH | Viscosity |
|---|---|---|---|
| A | Creamy flowable liquid | 6.1 | 3200 |
| B | Creamy flowable liquid | 6.1 | 2800 |
| C | Creamy flowable liquid | 6.1 | 2650 |

TABLE 12-B
Foam results of 2 in 1 Conditioning Shampoo Preparations
Of Formulations A, B and C of Example 13

| | Initial | Volume | |
|---|---|---|---|
| Shampoo | volume of | after 5 | |
| preparation | foam (mls) | min (mls) | Foam characteristics |
| A | 350 | 330 | Thick dense rich compact foam. |
| | | | No air between bubbles. |
| | | | Soft feel. |
| B | 300 | 270 | Thin, loose, scattered, airy foam. |
| | | | Not compact. No soft feel. |
| C | 300 | 260 | Thin, loose, scattered, airy foam. |
| | | | Not compact. No soft feel. |

Procedure: 1% of each formulation was dissolved in 200 mls. of water and shaken in a 500 mls. cylinder with 10 sets of shakes.

TABLE 12-C
Comparison of effects of 2 in 1 Conditioning Shampoo Preparations
of Formulations A, B and C of Example 13 on Hair Tresses

| | Formulation A | Formulation B | Formulation C |
|---|---|---|---|
| Dry comb | 2 | 5 | 4 |
| Wet comb | 2 | 4 | 4 |
| Detangling | 2 | 3 | 4 |
| Shine/gloss | 3 | 4 | 4 |
| Dryfeel/Handle | 2 | 4 | 5 |

All measurements are on a scale of 1-10, with I representing the best and 10 representing the worst.

Procedure: Rinsed hair tresses under tap water for 15 seconds. Rinsed hair tresses were Treated with shampoo. Mixed for 5 minutes. Removed the tresses and rinsed with tap water running on it for 15 seconds. Air dried. Performed wet and dry comb tests.

### EXAMPLE #14

### Ref # 134-106

Clear Conditioning Shampoo

TABLE # 13
(For Example #14)

| | A | B | C |
|---|---|---|---|
| Water | 51.2 | 51.2 | 51.2 |
| Sodium Laureth Sulfate 25% | 28.0 | 28.0 | 28.0 |
| Tauranol WS conc | 15.0 | 15.0 | 15.0 |
| Aminol HCA | 4.0 | 4.0 | 4.0 |
| Finsolv SUN | 1.0 | — | — |
| Isopropyl Myristate | — | 1.0 | — |
| Isopropyl Palmitate | — | — | 1.0 |
| Crothix | 0.3 | 0.3 | 0.3 |
| DMDM Hydantoin | 0.2 | 0.2 | 0.3 |

Procedure:

Charge water and heat to 75° C. Add all ingredients in order except DMDM Hydantoin, mixing well. Cool to 45° C. and add DMDM Hydantoin. Cool to room temperature.

Table 13-A compares the properties of shampoo preparations of formulations A, B & C of Example 14. Table 13-B compares properties of clear conditioning shampoo formulations A, B & C of Example 14. Table 13-C compares the effects of shampoo of formulations A, B & C on hair tresses.

TABLE # 13-A
Properties of clear conditioning shampoo
of formulations A, B & C of Example 14

| Shampoo Properties | Appearance | Clarity | Viscosity |
|---|---|---|---|
| A | Clear Gel | Clear | 12000 |
| B | Clear Gel | Clear | 9000 |
| C | Clear Gel | Clear | 8500 |

TABLE 13-B
Foam Results of Clear Conditioning Shampoo
Preparations of Formulations A, B & C of Example 14

| | Initial | Volume | |
|---|---|---|---|
| Shampoo | volume of | after 5 | |
| Formulation | Foam (mls) | Min (mls) | Foam Characteristics |
| A | 350 | 300 | Thick, dense stable foam |
| | | | compact. No gaps in-between |
| | | | bubbles. |
| B | 300 | 200 | Thin, loose, scattered; |
| | | | disappear quickly, gaps in- |
| | | | between bubbles. |
| C | 300 | 210 | Thin, loose, scattered, |
| | | | disappear quickly; gaps in- |
| | | | between bubbles. |

Procedure: 1% of the respective formulation was dissolved in 200 mls of water and shaken in a 500 ml. cylinder with 10 sets of shakes.

TABLE 13-C
Comparison of Effects of Clear Conditioning Shampoo
Preparations of Formulations A, B & C

| | A | B | C |
|---|---|---|---|
| Dry Comb | 4 | 5 | 5 |
| Wet Comb | 3 | 6 | 4 |
| Detangling | 2 | 5 | 3 |
| Shine/Gloss | 2 | 4 | 3 |
| Dry feel/Handle | 3 | 3 | 3 |

All measurements are on a scale of 1 to 10, with 1 representing the best and 10 representing the worst.

Procedure: Rinsed hair tresses under tap water for 15 seconds. Rinsed hair tresses were treated with shampoo, mixed for 5 minutes. Removed the tresses and rinsed with tap water running on it for 15 seconds, then air dried. Performed wet and dry comb.

### EXAMPLE # 15

### Ref # 134-107

Shower and Bath Gel

TABLE 14

| | | A | B | C |
|---|---|---|---|---|
| | Water | 48.0 | 48.0 | 48.0 |
| | 1,3 Butylene Glycol | 4.0 | 4.0 | 4.0 |
| | Tetra sodium EDTA | 0.1 | 0.1 | 0.1 |
| | DL Panthenol | 0.5 | 0.5 | 0.5 |
| | Sodium Laureth - sulfate | 20.0 | 20.0 | 20.0 |
| | Aminol HCA | 5.0 | 5.0 | 5.0 |
| | Fizul MD 318C | 4.0 | 4.0 | 4.0 |
| | Surfine AZI-A | 2.0 | 2.0 | 2.0 |
| | Finsolv SUN | 2.0 | — | — |
| | Isopropyl Myristate | — | 2.0 | — |
| | Isopropyl Palmitate | — | — | 2.0 |
| II | Crothix | 1.0 | 1.0 | 1.0 |
| | Sucrose Cocoate | 1.0 | 1.0 | 1.0 |
| III | DMDM Hydantoin 55% | 0.4 | 0.4 | 0.4 |
| | Citric acid 25% to pH 6.2 | qs | qs | qs |

Procedure:

Heat water to 50° C. and add all part I ingredients in order, allowing each to mix well. Raise temperature to 70° C. and add part II ingredients allowing each to mix well. Cool to 45° C. and add ingredients of part III. Cool to below 35° C. and adjust pH to 6.2. Pour warm.

Table 15-A compares the properties of shower & bath gel preparations of formulations A, B and C of Example 15.

TABLE 15-A
Properties of Shower and Bath Gel formulations A, B and C of
Example 15

| Shower & Bath Gel | Appearance | Clarity | Viscosity |
|---|---|---|---|
| A | Clear Gel | Clear | 7500 |
| B | Clear thin Gel | Clear | 5200 |
| C | Clear Thin Gel | Clear | 5080 |

TABLE 15-B
Foam Results of Shower and Bath Gel Preparations
of Formulations A, B and C of Example 15

| Shower & | Initial | | |
|---|---|---|---|
| Bath Gel | Volume Of | Volume after | |
| Formulation | Foam (mls) | 5 min (mls) | Foam Characteristics |
| A | 360 | 300 | Thick, dense, stable foam; |
| | | | compact, no gaps in-between |
| | | | bubbles. |
| B | 300 | 210 | Thin, small bubbles; scattered |
| | | | foam; gaps in-between |
| | | | bubbles. |
| C | 300 | 200 | Thin, small bubbles; scattered |
| | | | foam; gaps in-between |
| | | | bubbles. |

### EXAMPLE # 16

### Ref# 134-108

Foaming Facial Cleanser Cream

TABLE 16
(For Example #16)

| | | A | B | C |
|---|---|---|---|---|
| I | Tauranol I-78 (C) | 20 | 20 | 20 |
| | Finsolv SUN | 2 | — | — |
| | Isopropyl Myristate | — | 2 | — |
| | Isopropyl Palmitate | — | — | 2 |
| | 1,3 Butylene Glycol | 1 | 1 | 1 |
| | Water | 70 | 70 | 70 |
| II | Myristic acid | 3 | 3 | 3 |
| | Cetyl Alcohol | 2 | 2 | 2 |
| | Glyceryl Stearate | 2 | 2 | 2 |

Procedure:

Combine the contents of I and heat to 75° C. with gentle stirring until an homogeneous system is formed. Avoid aeration, separately combine II and heat with mixing to 60° C.

Add the molten II slowly to the vortex of I and continue stirring until cooled below 40° C. Resultant product builds viscosity and pearlescence in 48 hrs.

Table 16-A compares the properties of facial cleanser cream of formulations A, B and C of Example 16.

TABLE 16-A

| Foaming Cleanser cream | Appearance | Viscosity |
|---|---|---|
| A | Crème | 6000 |
| B | Creme | 4800 |
| C | Creme | 4500 |

TABLE 16-B
Foam Results of Foaming Facial Cleanse Creme.
Preparation of Formulations A, B and C of Example 16

| | Initial | Volume | |
|---|---|---|---|
| | volume | after | |
| | of Foam | 5 mins | |
| Formula | (mls) | (mls) | Foam Characteristics |
| A | 250 | 200 | Thick, dense, stable foam; compact, no |
| | | | gap in-between bubbles. |
| B | 220 | 180 | Thin, loose foam; scattered, disappear |
| | | | quickly, gap in-between bubbles. |
| C | 220 | 170 | Thin, loose foam, scattered, disappear |
| | | | quickly, gap in-between bubbles. |

Table 17 identifies the trade or generic names of the ingredients used in the examples set forth above.

The examples demonstrate the uses of the ester of the invention in personal care products, specifically, non-whitening antiperspirant stick, deodorant stick, pump spray deodorant, cream antiperspirant, emollient cleansing lotion, hand and body lotion, light body lotion, 2 in 1 conditioning shampoo (opaque cream type) clear conditioning shampoo, shower and bath gel, and foaming facial cleanser cream. These are considered to be representative of formulations wherein the ester of the invention finds application.

The formulations prepared using the compositions of the present invention have outstanding attributes in that the phenylethyl benzoate ester of the invention functions as an emollient and to raise the refractive index properties of the compositions to which it is added.

TABLE 17
Identification Of Trade Or Generic Listed Preparation Ingredients

| Trade or Generic Material | Identification | Source |
|---|---|---|
| Finsolv SUN | Phenyl Ethyl Benzoate | Finetex Inc., NJ |
| Aminol HCA | Cocoamide | Finetex Inc., NJ |
| Finsolv SLB-101 | Dimethicone PEG/PPG-20/30 Benzoate | Finetex Inc., NJ |
| Finsolv SLB-201 | Dimethicone PEG-8 Benzoate | Finetex Inc., NJ |
| Finsolv TN | C12-C15 Alkyl Benzoate | Finetex Inc., NJ |
| Finester EH 25 | C12-C15 Alkyl Octanoate | Finetex Inc., NJ |
| Finsolv PL-62 | Poloxmer 182 Dibenzoate | Finetex Inc., NJ |
| Finester DOM-R | Diethylhexyl Maleate | Finetex Inc., NJ |
| Finsoln EMG-20 | Methyl Gluceth - 20 Benzoate | Finetex Inc., NJ |
| Finsolv PL-355 | Poloxmer 105 Benzoate | Finetex Inc., NJ |
| Finsolv BCO-115 | Castor oil Benzoate | Finetex Inc., NJ |
| Finsolv BCR-111 | Cetyl Ricinoleate Benzoate | Finetex Inc., NJ |
| Finsolv BOHS-111 | Ethylhexyl Hydroxy stearate Benzoate | Finetex Inc., NJ |
| Crothix | PEG-150 Pentaerythrityl tetrastearate | Croda Inc., NJ |
| Tauranol I 78 C | Sodium Cocyl Isethionate | Finetex Inc., NJ |
| Tauranol WS (cons) | Sodium Methyl cocyl Taurate | Finetex Inc., NJ |
| Surfine-AZI-A | Nonoxynol-10 Carboxylate | Finetex Inc., NJ |
| Sodium Stearate C7 | Sodium Stearate | Witco Corporation, TX |
| Dow Corning Fluid 244/344 | cyclomethicone | Dow Corning, MI |
| Dow Corning Fluid 200 | Dimethicone | Dow Corning, MI |
| Carbomer | Carbopol ETD 2001 Resin | B.F. Godrich, OH |
| Triclosan | Irgasan DP 300 | Ciba Specialty Chemicals, NC |
| Dow Corning Fluid 345 | Cyclomethicone | Dow Corning, MI |
| Adol 62 | Stearyl Alchol | Witco Corporation, TX |
| Reach AZP 908 | Aluminum Zirconium Tetrachloro-Glycine | Reheis Inc., NJ |
| Silica | Cabosil M - 5 | Cabot Corp, IL |
| Germaben II | Diazolidinyl urea | ISP, NJ |
| Witconol 2314 | Isopropyl myristate | Witco Corporation, TX |
| Witconol 2316 | Isopropyl palmitate | Witco Corporation, TX |
| Finsolv SB | Isostearyl benzoate | Finetex Inc., NJ |
| Finsolv PG22 | Dipropylene Glycol Dibenzoate | Finetex Inc., NJ |
| Finsolv BOD | Octyldodecyl Benzoate | Finetex Inc., NJ |

It will be understood that the embodiments described herein are merely exemplary and that a person skilled in the art may make many variations and modifications without departing from the spirit and scope of the invention. All such variations and modifications are intended to be included in the scope of the invention as described herein.

1. An antiperspirant composition in the form of a spray, liquid, creme, paste, bar, granules or stick comprising from about 0.5% to about 25% by weight of phenylethyl benzoate, and from about 0.5% to about 50% by weight of antiperspirant actives in a dermatologically acceptable carrier.

2. The antiperspirant composition of claim 1 wherein said antiperspirant actives are selected from the group consisting of aluminum chlorohydrate and aluminum zirconium tetrachloro-glycine.

3. The antiperspirant composition of claim 1 further comprising adjunct ingredients selected from one or more members of the group consisting of conditioning agents, fatty substances, organic solvents, thickening agents, emollients, emulsifiers, humectants, softeners, lubricants, penetrants, plasticizers, antioxidants, agents for combating free radicals, opacifiers, stabilizers, emollients, solvents and co-solvents, dispersants, silicones, alpha-hydroxy acids, buffers, chelating agents, foaming agents, antifoaming agents, moisturizing agents, vitamins, insect repellents, fragrances, preservatives, surfactants, anti-inflammatories, pH adjusters, chelating agents, fillers, polymers, propellants, basifying or acidifying agents, odor masking agents, tanning agents, colorants and mixtures thereof.

4. The composition of claim 1 wherein said composition is a topical anti-perspirant selected from the group consisting of antiperspirant stick, clear deodorant stick, antiperspirant gel and antiperspirant spray.

5. The antiperspirant composition of claim 1 preferably comprising from about 1% to about 10% by weight of phenylethyl benzoate, and from about 1% to about 50% by weight of antiperspirant actives.

6. A method of protecting human skin from perspiration comprising the step of contacting the skin with an anhydrous or an aqueous medium containing an effective amount of an antiperspirant composition according to claim 1.

7. A personal care composition comprising phenylethyl benzoate in the amount of from about 0.5% to about 50% by weight of the composition, and at least one functional ingredient present in the amount of from about 0.1 to 50% by weight of the composition.

8. The personal care composition of claim 7 wherein said composition is selected from the group consisting of antiperspirants and deodorants, soaps, shampoos, hair conditioners, emollient cleansing lotions, and hand and body lotions.

9. The personal care composition of claim 7, wherein said functional ingredient is an active ingredient selected from the group consisting of antiperspirant actives, surfactants, moisturizers, and conditioners.

10. The composition of claim 9, wherein said active antiperspirant actives are selected from the group consisting of aluminum chlorohydrate and aluminum zirconium tetrachloro-glycine.

11. The composition of claim 7 which is in the form selected from the group consisting of liquid, cream, gel, paste, bar, granules, stick, emulsion, dispersion, suspension, powder, foam or spray.

12. The composition of claim 7 further comprising one or more additional ingredients selected from the group consisting of conditioning agents, fatty substances, organic solvents, thickening agents, emollients, emulsifiers, humectants, softeners, lubricants, penetrants, plasticizers, antioxidants, agents for combating free radicals, opacifiers, stabilizers, emollients, solvents and co-solvents, dispersants, silicones, alpha-hydroxy acids, buffers, chelating agents, foaming agents, antifoaming agents, moisturizing agents, vitamins, insect repellents, fragrances, preservatives, surfactants, anti-inflammatories, pH adjusters, chelating agents, fillers, polymers, propellants, basifying or acidifying agents, odor masking agents, tanning agents, colorants and mixtures thereof.
